(19) United States
(12) Patent Application Publication
(10) Pub. No.: US 2024/0322225 A1
(43) Pub. Date: Sep. 26, 2024

(54) SOLID-STATE BATTERY, AND FIBER

(71) Applicant: HONDA MOTOR CO., LTD., Tokyo (JP)

(72) Inventors: Masahiro OHTA, Saitama (JP); Masanari HIGUCHI, Saitama (JP); Atsushi OGAWA, Saitama (JP)

(21) Appl. No.: 18/583,877

(22) Filed: Feb. 22, 2024

(30) Foreign Application Priority Data
Mar. 22, 2023 (JP) 2023-044984

(51) Int. Cl. H01M 10/0562

(52) U.S. Cl. CPC H01M 10/0562

(57) ABSTRACT

A solid-state battery is provided which can improve the adhesion between a solid electrolyte layer and electrode layer, and ion conductivity. A solid-state battery includes a positive electrode layer containing a positive electrode active material; a negative electrode layer; and a solid electrolyte layer containing solid electrolyte and disposed between the positive electrode layer and the negative electrode layer, in which at least either of an interface between the positive electrode layer and the solid electrolyte layer, and an interface between the negative electrode layer and solid electrolyte layer has fiber coated by the solid electrolyte.

This application is based on and claims the benefit of priority from Japanese Patent Application No. 2023-044984, filed on 22 Mar. 2023, the content of which is incorporated herein by reference.

### BACKGROUND OF THE INVENTION

### Field of the Invention

The present invention relates to a solid-state battery and a fiber.

### Related Art

In recent years, in order to configure so as to be able to maintain access to sustainable and advancing energy which is affordable and reliable for many people, research and development has been carried out on secondary batteries which contribute to higher efficiency in energy.

As such a secondary battery, solid-state batteries such as lithium-ion secondary batteries have been known in which a solid electrolyte layer is arranged between the positive electrode layer and negative electrode layer.

As a solid-state battery, in a battery having a gel-like or solid electrolyte, by the electrolyte having inorganic particles equipped with an antioxidation property and heat resistance property, technology raising the antioxidation property and heat resistance property of a top layer opposing a positive electrode member has been disclosed (for example, refer to Patent Document 1).
Patent Document 1: Japanese Patent No. 6683259

### SUMMARY OF THE INVENTION

However, the adhesion of the interface between the solid electrolyte layer and positive electrode layer or negative electrode layer (electrode layer) of the solid-state battery depends on mostly Van der Waals force, and thus the bonding strength is relatively low. For this reason, there are problems in that high energy densification of the battery by increasing area is difficult, or low durability of the battery. Alternatively, there is a problem in that, as a result of a retention mechanism having high retention force being necessary, the cost of the member increases, and the volume energy efficiency of batteries declines.

The present invention has been made taking account of the above, and has an object of providing a solid-state battery which can improve the adhesion of the boundary between a solid electrolyte layer and electrode layer, and ion conductivity.

A first aspect of the present invention relates to a solid-state battery including: a positive electrode layer containing a positive electrode active material; a negative electrode layer; and a solid electrolyte layer containing solid electrolyte and disposed between the positive electrode layer and the negative electrode layer, in which at least either of an interface between the positive electrode layer and the solid electrolyte layer, and an interface between the negative electrode layer and the solid electrolyte layer includes a fiber coated by a solid electrolyte.

According to the first aspect of the present invention, it is possible to provide a solid-state battery which can improve the adhesion at an interface between the solid electrolyte layer and the electrode layer, and the ion conductivity.

According to a second aspect of the present invention, in the solid-state battery as described in the first aspect, the solid electrolyte coating the fiber is a same type of material as the solid electrolyte contained in the solid electrolyte layer.

According to the second aspect of the present invention, the compatibility of the fiber coated by solid electrolyte and the solid electrolyte layer gets better, and the dispersibility improves. Therefore, at the interface of each layer, it is possible to further improve the bonding strength of each layer, and the ion conductivity.

According to a third aspect of the present invention, in the solid-state battery as described in the first aspect, the solid electrolyte coating the fiber has a Young's modulus higher than the solid electrolyte contained in the solid electrolyte layer.

According to the third aspect of the present invention, upon forming the solid-state battery, the anchoring effect improves upon the fiber coated by the solid electrolyte penetrating into another layer via the interface of each layer. Therefore, at the interface of each layer, it is possible to further improve the bonding strength of each layer, and the ion conductivity.

According to a fourth aspect of the present invention, in the solid-state battery as described in any one of the first to third aspects, the fiber has a Young's modulus higher than the solid electrolyte contained in the solid electrolyte layer.

According to the fourth aspect of the present invention, upon forming the solid-state battery, the anchoring effect improves upon the fiber coated by the solid electrolyte penetrating into another layer via the interface of each layer. Therefore, at the interface of each layer, it is possible to further improve the bonding strength of each layer, and the ion conductivity.

According to a fifth aspect of the present invention, in the solid-state battery as described in any one of the first to fourth aspects, an average particle size of the solid electrolyte coating the fiber is in a range of 1 nm to 500 nm.

According to the fifth aspect of the present invention, it is possible to more favorably coat the fibers than the solid electrolyte of the solid electrolyte layer.

According to a sixth aspect of the present invention, in the solid-state battery as described in the first or second aspect, the fiber penetrates to a plurality of layers adjacent to the interface.

According to the sixth aspect of the present invention, the anchoring effect is exhibited by the fibers coated by the solid electrolyte penetrating to another layer adjacent thereto via the interface of respective layers. Therefore, at the interface of each layer, it is possible to further improve the bonding strength of each layer, and the ion conductivity.

In addition, a seventh aspect of the present invention relates to a fiber coated by a solid electrolyte, the fiber being used in a solid-state battery including a positive electrode layer containing a positive electrode active material; a negative electrode layer; and a solid electrolyte layer containing solid electrolyte and disposed between the positive electrode layer and the negative electrode layer, and being for joining the positive electrode layer and the solid electrolyte layer, or for joining the negative electrode layer and the solid electrolyte layer.

According to the seventh aspect of the present invention, it is possible to produce a solid-state battery which can improve the adhesion of the boundary between a solid electrolyte layer and electrode layer, and ion conductivity.

### BRIEF DESCRIPTION OF THE DRAWINGS

FIG. 1 is a view showing the configuration of a solid-state battery according to an embodiment of the present invention; and

FIG. 2 is a view showing the configuration of fiber according to an embodiment of the present invention.

### DETAILED DESCRIPTION OF THE INVENTION

### <Solid-State Battery>

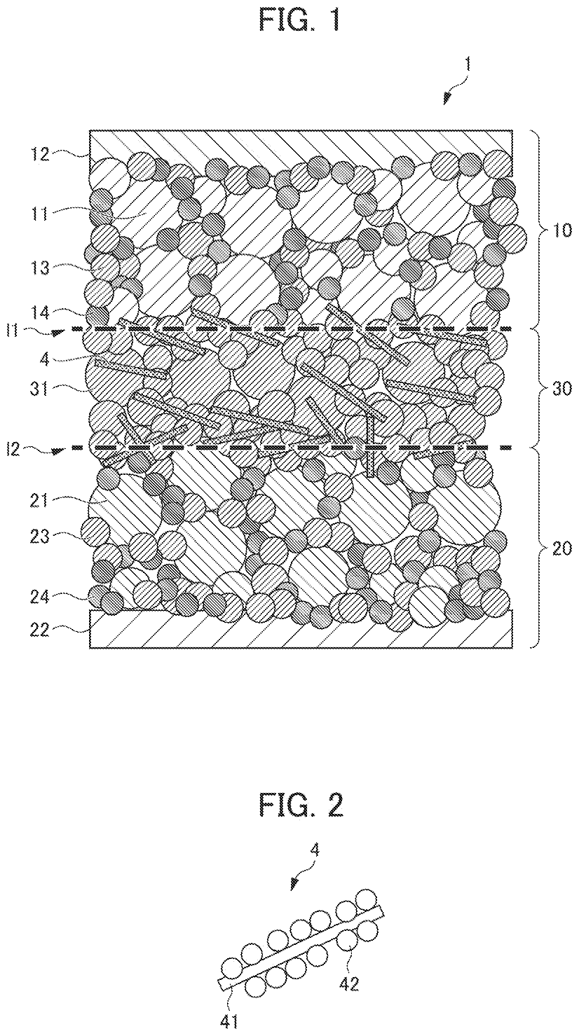

Hereinafter, an embodiment of the present invention will be explained while referencing the drawings. FIG. 1 is a cross-sectional view schematically showing the configuration of a solid-state battery 1 according to the present embodiment. The solid-state battery 1 includes a negative electrode layer 10, a positive electrode layer 20, and a solid electrolyte layer 30 arranged between the negative electrode layer 10 and positive electrode layer 20, as shown in FIG. 1. FIG. 1 shows a configuration in which each layer is laminated one by one; however, the number of layers is not particularly limited.

As the above solid-state battery 1, an all solid-state lithium ion battery having a solid electrolyte can be exemplified. The above solid-state battery 1 is particularly preferably an all solid lithium metal using lithium metal as the negative electrode, or a silicon negative electrode all lithium battery using silicon. This is because the configuration of the present invention which can improve the adhesion between the solid electrolyte layer and electrode layer being more effective due to these batteries having relatively large expansion and contraction from charging/discharging.

### (Negative Electrode Layer)

The negative electrode layer 10 has a negative electrode active material layer containing essentially a negative electrode active material 11, and containing optionally a solid electrolyte 13, conductivity aid 14, etc., and a negative electrode current collector 12. In the negative electrode active material layer, a known material as an electrode material of a solid-state battery such as a binder may be included.

The negative electrode active material 11 is not particularly limited; however, for example, lithium transition metal oxides such as lithium titanate (Li₄Ti₅O₁₂), transition metal oxides such as TiO₂, Nb₂O₃ and WO₃, metal sulfides, metal nitrides, carbon materials such as graphite, soft carbon and hard carbon, silicon-based materials such as silicon single crystal, silicon alloy and silicon compounds, as well as lithium metal, lithium alloy and indium metal can be exemplified.

The negative electrode collector 12 is not particularly limited, and can use a known material as the negative electrode current collector of a solid-state battery. The negative electrode collector 12 is exemplified by metal foils such as copper (Cu) foil and stainless (SUS) foil.

The solid electrolyte 13 is not particularly limited so long as being a material which can conduct lithium ions; however, for example, a sulfide-based solid electrolyte material, oxide-based solid electrolyte material, nitride-based solid electrolyte material, halide-based solid electrolyte material, etc. can be exemplified.

The conductivity aid 14 is a known material as an electrode material of a solid-state battery, and is not particularly limited so long as having electron conductivity; however, for example, carbon materials such as acetylene black, and metal materials can be exemplified.

### (Positive Electrode Layer)

The positive electrode layer 20 includes a positive electrode active material layer essentially containing the positive electrode active material 21, and optionally containing the solid electrolyte 23 and conductivity aid 24, and the positive electrode collector 22. Other than the above, the positive electrode active material layer may contain a known material as an electrode material of a solid-state battery such as a binder.

The positive electrode active material 21 is not particularly limited; however, for example, LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}CO_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, sulfur, etc. can be exemplified.

The positive electrode current collector 22 is not particularly limited; however, for example, aluminum (Al) foil, stainless steel (SUS) foil, etc. can be exemplified.

As the solid electrolyte 23 and conductivity aid 24, it is possible to adopt configurations similar to the above solid electrolyte 13 and conductivity aid 14, respectively.

### (Solid Electrolyte Layer)

The solid electrolyte layer 30 necessarily contains the solid electrolyte 31. The solid electrolyte layer 30 may contain a binder or the like, other than the above.

As the solid electrolyte 31, it is possible to adopt a configuration similar to the above solid electrolytes 13, 23.

The solid electrolyte 31 preferably has a Young's modulus (rigidity) lower than the fiber 41 described later. In addition, the solid electrolyte 31 preferably has a Young's modulus (rigidity) lower than the solid electrolyte 42 described later.

As the solid electrolyte 31, for example, Li₃PS₄ (Young's modulus: 18 to 25 GPa), Li₁₀GeP₂S₁₂ (Young's modulus: 21 GPa or less), Li₃PO₄ (Young's modulus: 50 GPa or less), Li_{2.9}PO_{3.3}N_{0.46} (Young's modulus: 50 GPa or less), etc. can be exemplified. The solid electrolyte 31 having a Young's modulus lower than the fiber 41 and/or solid electrolyte 42 can be selected as appropriate according to the Young's modulus of the fiber 41 and solid electrolyte 42 selected.

### <Coated Fiber>

In the solid-state battery 1, in at least either of an interface I1 between the negative electrode layer 10 and solid electrolyte layer 30, and an interface I2 between the positive electrode layer 20 and solid electrolyte layer 30, a coated fiber 4 is present as fiber coated by the solid electrolyte. By the coated fiber 4 being present at the above interface I1 and/or interface I2, the anchoring effect is exhibited in addition to van der Waals forces, and the negative electrode layer 10 and/or positive electrode layer 20 and the solid electrolyte layer 30 are mechanically bonded. Therefore, it is possible to raise the adhesion between the negative electrode layer 10 and/or positive electrode layer 20 and the solid electrolyte layer 30. For this reason, it is possible to reduce the content of binder contained in the electrode layers and solid electrolyte layer, and thus possible to improve the ion conductivity.

An outline for the configuration of the coated fiber 4 is shown in FIG. 2. The coated fiber 4 is made by the fiber 41 being covered by the solid electrolyte 42.

The fiber 41 preferably has a Young's modulus (rigidity) higher than the solid electrolyte 31 contained in the solid electrolyte layer 30. Upon forming the solid-state battery 1, the anchoring effect thereby improves upon the coated fiber 4 penetrating into another layer via the interface I1 or interface I2. Therefore, it is possible to further improve the adhesion between the negative electrode layer 10 and/or positive electrode layer 20 and the solid electrolyte layer 30.

As the above such fiber 41, for example, a non-electron conductive ceramic fiber can be exemplified. More specifically, alumina (Young's modulus: 360 to 470 GPa), zirconia (Young's modulus: 200 GPa), silicon nitride (Young's modulus: 300 GPa), silicon carbide (Young's modulus: 440 GPa), alumina nitride (Young's modulus: 320 GPa), Li₇La₃Zr₂O₁₂ (LLZ, Young's modulus: 130 to 150 GPa), Li₃PO₄ (Young's modulus: 50 GPa or less), Li₃PO₄Nₓ in which nitrogen is added to lithium phosphate (LIPON, Young's modulus: 50 GPa or less), etc. can be exemplified. A fiber 41 having a Young's modulus of at least the solid electrolyte 31 can be selected as appropriate according to the Young's modulus of the selected solid electrolyte 31.

The radius of the fiber 41 is preferably no more than ⅕ of the radius of the solid electrolyte 42, for example. The affinity between the fiber 41 and solid electrolyte 42 thereby improves, and it is possible to reduce the loss of the solid electrolyte 42 from the surface of the fiber 41, during anchor formation to the positive electrode layer or negative electrode layer.

The length of the fiber 41, for example, is preferably no more than the total of the thickness of the negative electrode active material layer, solid electrolyte layer 30 and positive electrode active material layer. It is thereby possible to prevent the fiber 41 from damaging the current collector.

The aspect ratio of the fiber 41 is preferably at least 5, for example. It is thereby possible to enlarge the intrusion amount to the positive electrode layer or negative electrode layer, and thus a greater anchoring effect can be obtained.

The solid electrolyte 42 covers the surface of the fiber 41. By the surface of the fiber 41 being coated by the solid electrolyte 42, the ion conductivity of the coated fiber 4 improves. Therefore, it is possible to further improve the ion conductivity of each layer at the above interface I1 and interface I2. A similar configuration as the above-mentioned solid electrolytes 13, 23, 31 can be adopted for the solid electrolyte 42.

The solid electrolyte 42 is preferably the same type of solid electrolyte as the solid electrolyte 31. The compatibility of the coated fiber 4 and solid electrolyte 31 thereby gets better, and the dispersibility of coated fibers 4 improves. Therefore, at the interface I1 and/or interface I2, it is possible to further improve the bonding strength between the negative electrode layer 10 and/or positive electrode layer 20 and the solid electrolyte layer 30, and the ion conductivity.

On the other hand, the solid electrolyte 42 preferably has a Young's modulus (rigidity) of at least the solid electrolyte 31. Upon forming the solid-state battery 1, the anchoring effect upon the coated fiber 4 penetrating to another layer via the interface I1 or interface I2 improves. Therefore, it is possible to further improve the adhesion between the negative electrode layer 10 and/or positive electrode layer 20 and the solid electrolyte layer 30.

As the solid electrolyte 42 having a Young's modulus (rigidity) of at least the solid electrolyte 31, for example, Li₇La₃Zr₂O₁₂ (LLZ, Young's modulus: 130˜150 GPa), Li₃PO₄ (Young's modulus: 50 GPa or less), Li_{2.9}PO_{3.3}N_{0.46} (Young's modulus: 50 GPa or less), etc. can be exemplified. The above-mentioned solid electrolyte 42 can be appropriately selected according to the Young's modulus of the selected solid electrolyte 31.

The solid electrolyte 42 preferably has an average particle size (D50) of 1 nm to 500 nm, for example. It is thereby possible to suitably coat the fiber 41.

### (Production Method of Solid-State Battery)

The production method of the solid-state battery 1 is not particularly limited, and can apply a well-known method. As the method of forming the positive electrode layer and negative electrode layer, for example, a method which prepares an electrode mixed material slurry by dissolving or dispersing the material constituting the electrode active material layer such as the electrode active material into a solvent, coating onto the surface of the current collector, and drying can be exemplified. As the method forming the solid electrolyte layer, a method which coats the solid electrolyte slurry prepared by dissolving or dispersing the solid electrolyte in a solvent on any object and drying can be exemplified. The above-mentioned means of coating is not particularly limited, and an inkjet method, screen printing method, doctor blade method or the like can be exemplified. It should be noted that, in order to allow the coated fiber 4 to be present at the interface I1 or I2 of the solid-state battery 1, a method which causes the coated fiber 4 to mix into either of the above-mentioned electrode mixed material slurry or solid electrolyte slurry can be exemplified.

The solid-state battery 1 (laminate body) can be produced by laminating each of the above formed layers and optionally pressing. The method of pressing may be uniaxial compression joining; however, it is preferably a method by roll pressing. This is because, by roll pressing, since the coated fiber 4 moves so as to be oriented in the feeding direction of the laminate body, the coated fiber tends to be arranged at the interface I1 or I2.

### (Production Method of Coated Fiber)

The production method of the coated fiber 4 can be exemplified by a solution method, for example. The solution method can be applied to Li₃PS₄, Li₁₀GeP₂S₁₂, or the like, which are sulfur-based solid electrolytes, as the solid electrolyte 42. In the solution method, first, the solution of the solid electrolyte 42 is prepared by mixing and dissolving the solid electrolyte 42 (for example, Li₃PS₄) in the solvent (for example, N-methylformamide). The fiber 41 (coated fiber 4) coated by the solid electrolyte 42 can be produced by mixing the fiber 41 (for example, alumina) thereinto and vacuum drying. It should be noted that the average particle size of the solid electrolyte 42 can be adjusted by the concentration of solid electrolyte 42 during preparation of the above electrolytic solution, or the temperature during vacuum drying.

The production method of the coated fiber 4 can be exemplified by a sputtering deposition method and laser ablation method, in addition to the above. The sputtering deposition method and laser ablation method can be applied to Li₇La₃Zr₂O₁₂, Li₃PO₄, Li_{2.9}PO_{3.3}N_{0.46}, etc. which are oxide solid electrolytes, as the solid electrolyte 42. In the sputtering deposition method and laser ablation method, first, the solid electrolyte 42 (for example, Li₇La₃Zr₂O₁₂) is compressed at a predetermined pressure, and molded to obtain a green compact (bulk body). Next, in the sputtering deposition method, the target is established as the above green compact (bulk body) and noble gas (argon or the like) is made to collide therewith in a vacuum, whereby it is possible to produce the fiber 41 coated with the solid electrolyte 42 (coated fiber 4). In the laser ablation method, a pulse laser is irradiated in place of the above-mentioned noble gas.

The production method of the coated fiber 4 is not limited to the above, and an alkoxide solution method can be used, using a complex alkoxide consisting of lithium alkoxide, lanthanum alkoxide, and zirconium alkoxide.

Although a preferred embodiment of the present invention has been explained above, the present invention is not to be limited to the above embodiment, and modifications and improvements of a scope which can achieve the object of the present invention are also encompassed by the present invention.

### EXPLANATION OF REFERENCE NUMERALS

1 solid-state battery
10 negative electrode layer
20 positive electrode layer
21 positive electrode active material
30 solid electrolyte layer
31 solid electrolyte
4 coated fiber (fiber coated by solid electrolyte)
41 fiber
42 solid electrolyte
I1, I2 interface

What is claimed is:

1. A solid-state battery comprising: a positive electrode layer containing a positive electrode active material; a negative electrode layer; and a solid electrolyte layer containing solid electrolyte and disposed between the positive electrode layer and the negative electrode layer,
wherein at least either of an interface between the positive electrode layer and the solid electrolyte layer, and an interface between the negative electrode layer and the solid electrolyte layer includes a fiber coated by a solid electrolyte.

2. The solid-state battery according to claim 1, wherein the solid electrolyte coating the fiber is a same type of material as the solid electrolyte contained in the solid electrolyte layer.

3. The solid-state battery according to claim 1, wherein the solid electrolyte coating the fiber has a Young's modulus higher than the solid electrolyte contained in the solid electrolyte layer.

4. The solid-state battery according to claim 1, wherein the fiber has a Young's modulus higher than the solid electrolyte contained in the solid electrolyte layer.

5. The solid-state battery according to claim 1, wherein an average particle size of the solid electrolyte coating the fiber is in a range of 1 nm to 500 nm.

6. The solid-state battery according to claim 1, wherein the fiber penetrates to a plurality of layers adjacent to the interface.

7. A fiber coated by a solid electrolyte, the fiber being used in a solid-state battery comprising a positive electrode layer containing a positive electrode active material; a negative electrode layer; and a solid electrolyte layer containing solid electrolyte and disposed between the positive electrode layer and the negative electrode layer, and being for joining the positive electrode layer and the solid electrolyte layer, or for joining the negative electrode layer and the solid electrolyte layer.
